(19) United States
(12) Patent Application Publication
(10) Pub. No.: US 2006/0290483 A1
(43) Pub. Date: Dec. 28, 2006

(54) Leonard lightup lockin

(76) Inventors: Roy L. Leonard JR., Penn Hills, PA (US); Shirley A. Sharp, Tarentum, PA (US)

Correspondence Address: ROY L. LEONARD JR., 115 McCUTCHEON LANE, PENN HILLS, PA, 15235, US

(21) Appl. No.: 10/953,672

(22) Filed: May 31, 2005

(51) Int. Cl. B60Q 1/00

(52) U.S. Cl. 340/438; 340/457.1

(57) ABSTRACT

A highly reflective device that integrates with automobile seatbelt safety systems. The advantages are that it shows that the driver and passenger(s) are wearing their seatbelts. However, it also makes wearing the seatbelt fashionable without altering the effectiveness of the seatbelt's safety.

A highly reflective device that integrates with automobile seatbelt safety systems. The advantages are that it shows that the driver and passenger(s) are wearing their seatbelts. However, it also makes wearing the seatbelt fashionable without altering the effectiveness of the seatbelt's safety.

### ASSEMBLY

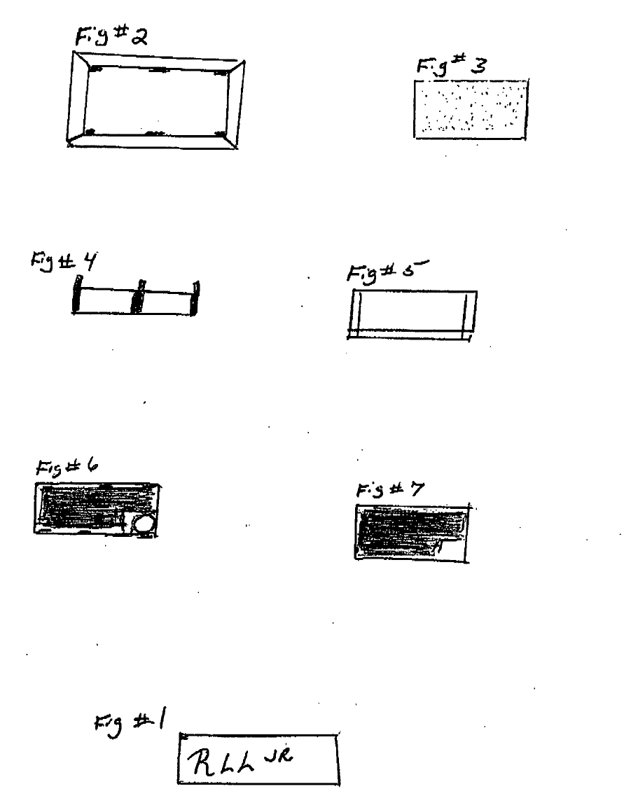

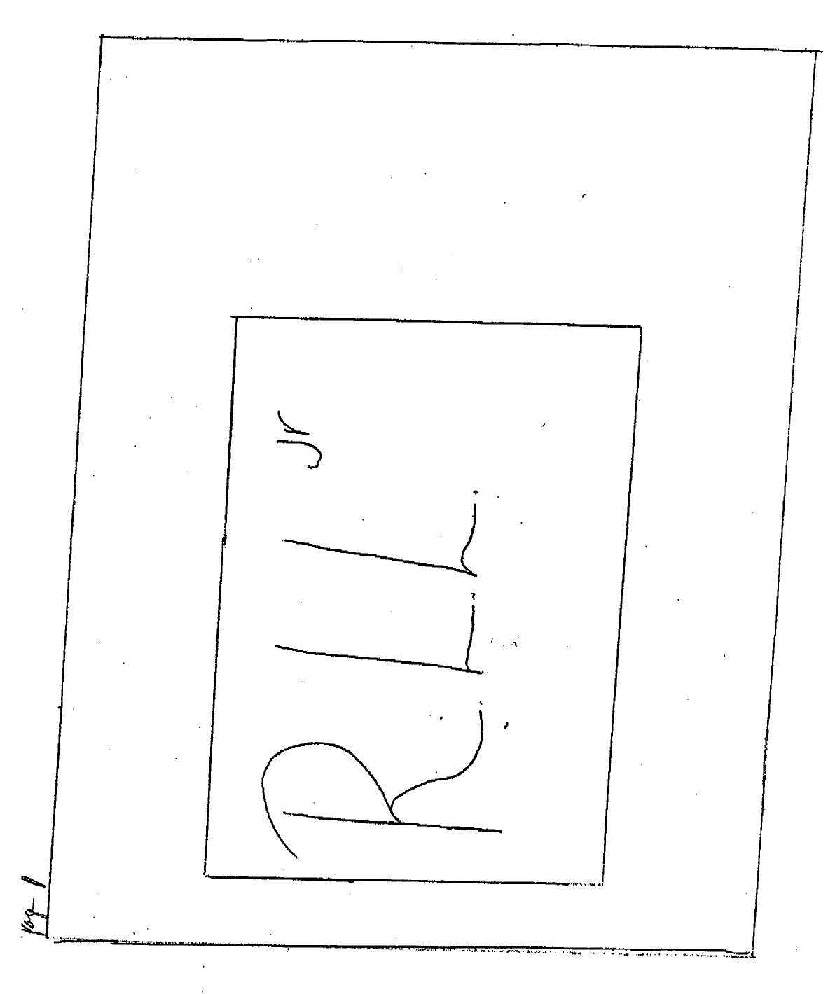

FIG. 1. Finished product 1.875″ (1⅞″) wide×10″ long

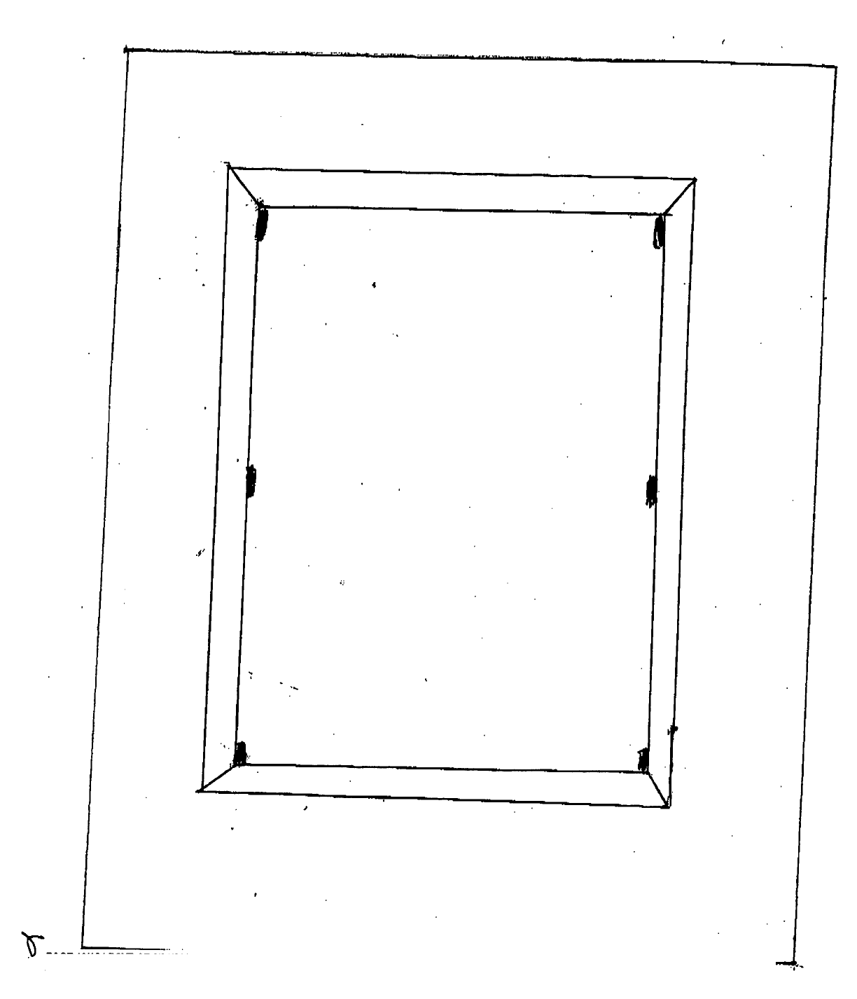

FIG. 2 Top plate is a clear box that fits on top of perforated plate

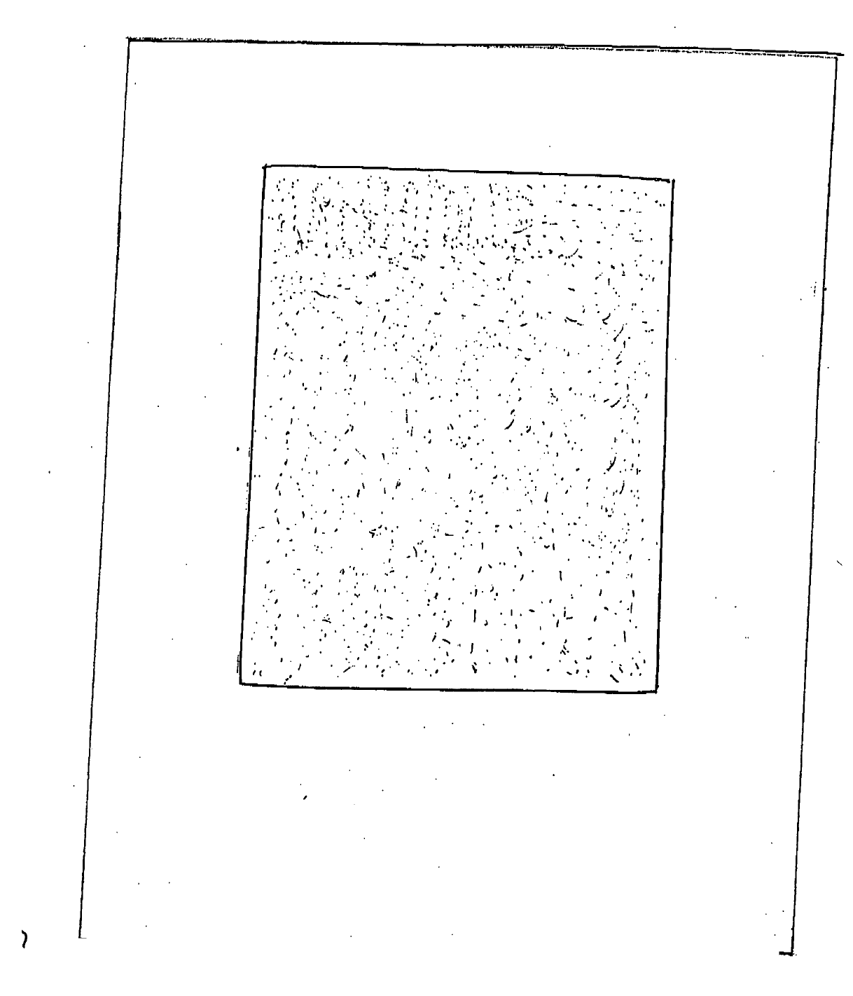

FIG. 3 Perforated plate

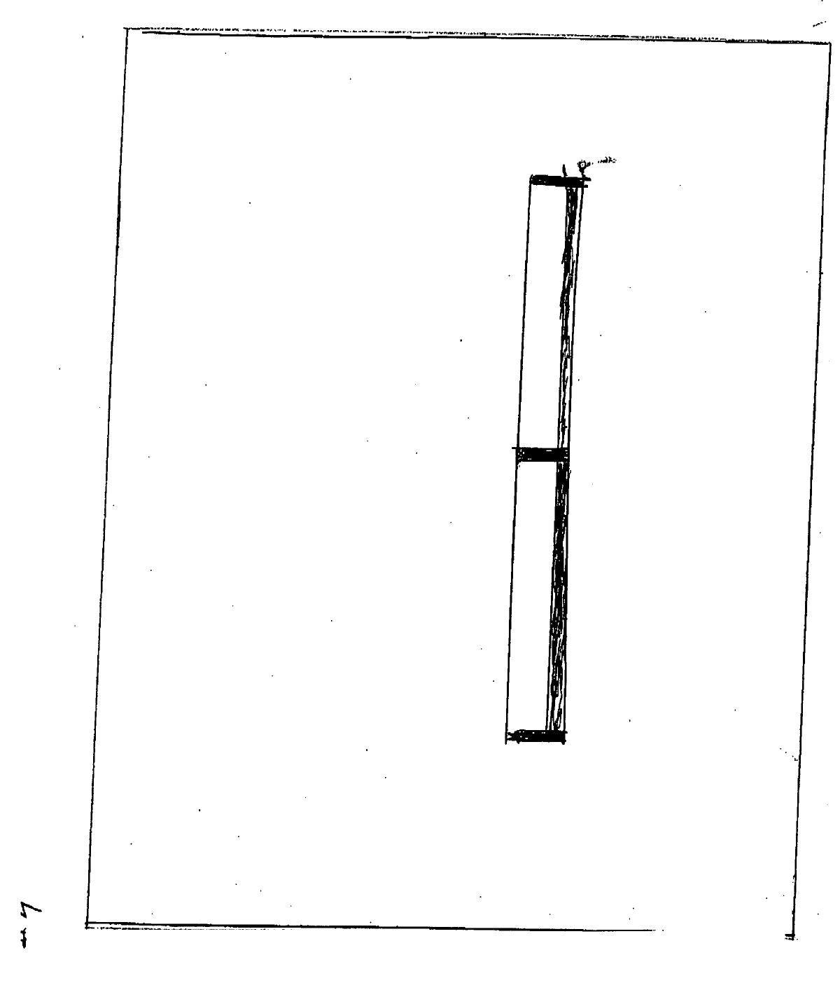

FIG. 4 Right side view

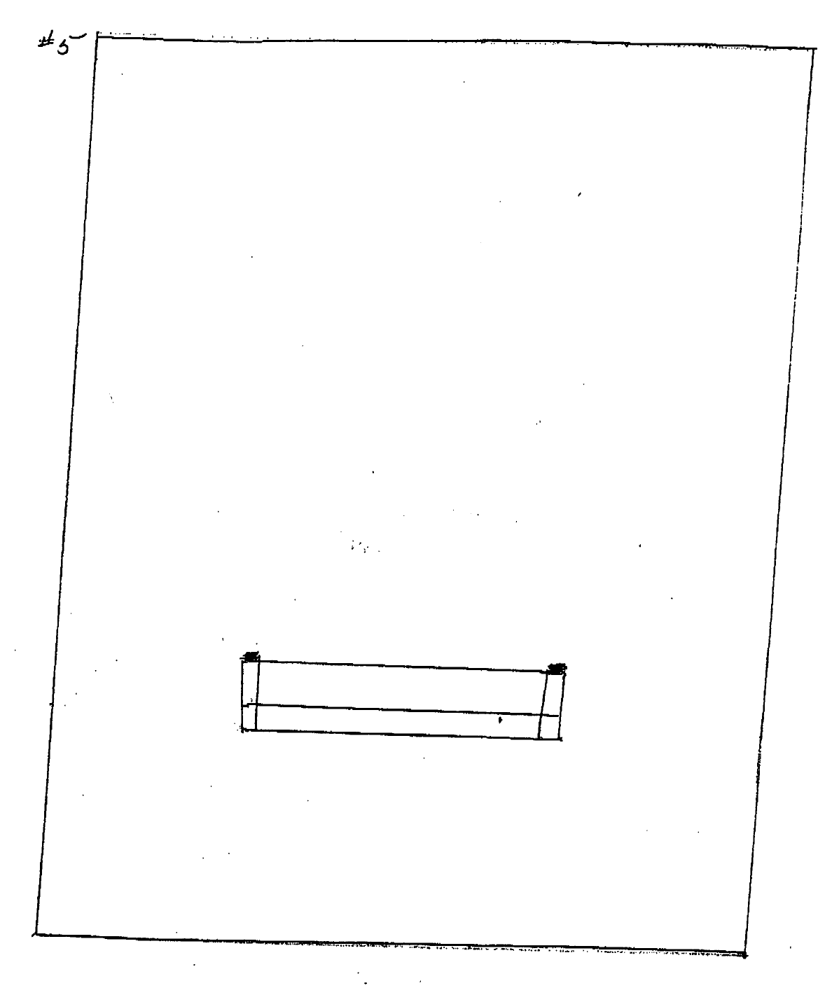

FIG. 5 Bottom view

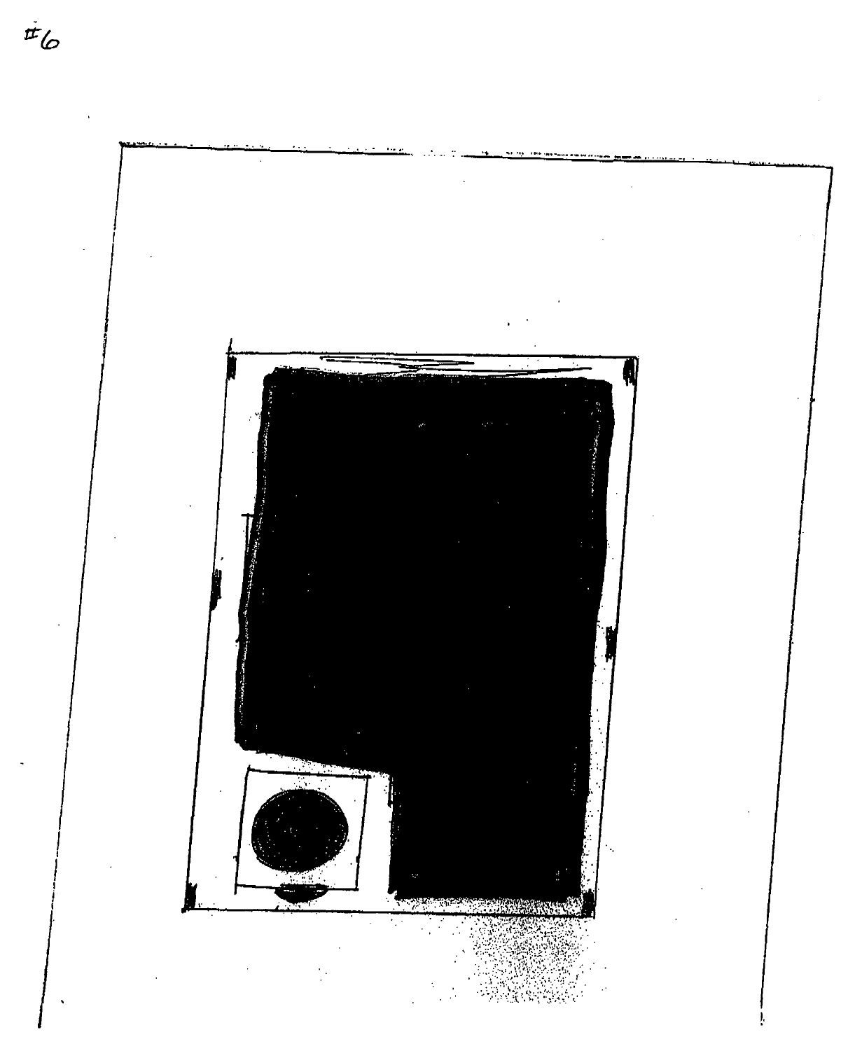

FIG. 6 Sub assembly with battery, fits under perforated plate, has Velcro bottom

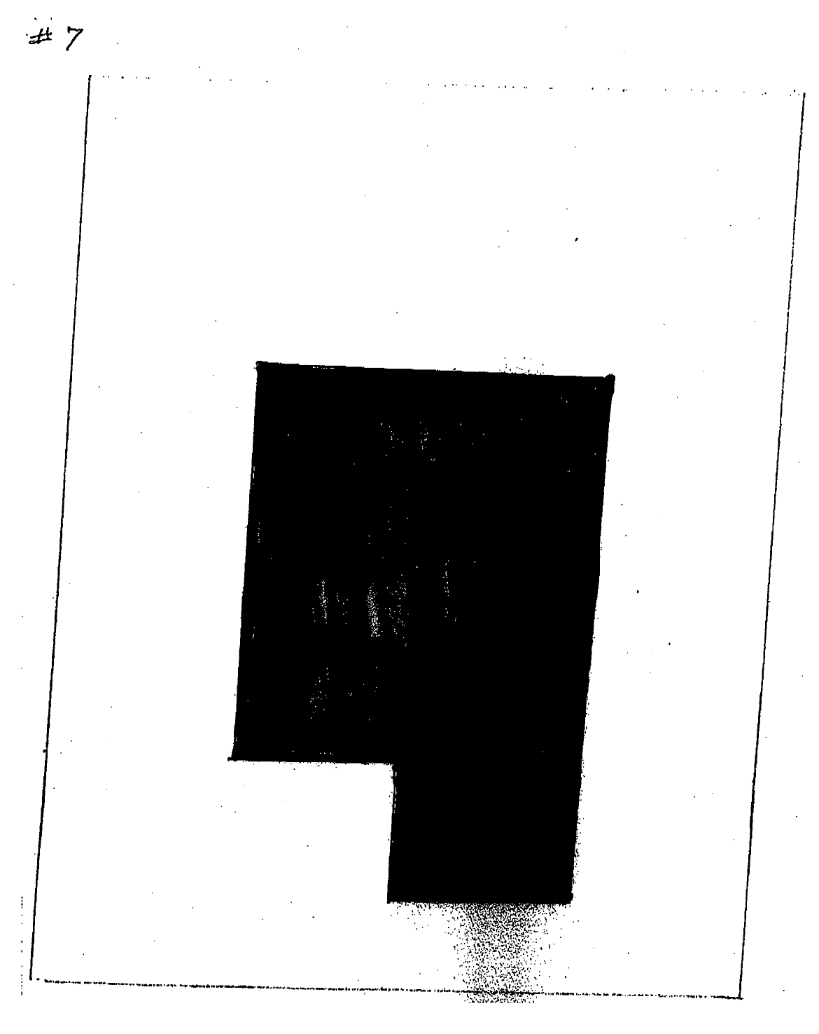

FIG. 7 The bottom plate is made of Velcro that holds the reflective letter kit in Place with an adhesive side.

1. Proposed Implementations
Highly visible, reflective and/or fluorescent, bright illuminated colors.
Choice of two models: Perforated LightUp kit or Reflective letter and or numbers kit.
Kit allows for customizable messages using various types of alphanumeric characters and symbols.
Great for police, EMS fireman, doctors, clergy, logos etc. . . .
Great way to display automobile manufacturer's emblem.
Made of durable soft plastic with a perforated light up kit.
May be integrated into vehicle assembly and or sold separately as an easy to assemble aftermarket kit.
Adaptable to children's car seats and strollers.
May also be modified for use as house numbers, family names, mailboxes etc. . . .
Possible retailers include department stores, auto parts stores, convenience stores, vendors, etc. . . .
Possible retail price range from $14.99 to $21.99
Advantages
Law enforcement can easily see the reflective properties of the device from a distance.
Makes safety compliance with buckle-up laws both fun and fashionable for all ages
Visible for people to see at drive-thru windows, toll booths, and weight stations.
